(19) United States
(12) Patent Application Publication
(10) Pub. No.: US 2005/0092038 A1
(43) Pub. Date: May 5, 2005

(54) Lock for two-wheeled vehicles

(76) Inventor: Thomas Becker, Hunfelden (DE)

Correspondence Address: GREENBERG TRAURIG, LLP, MET LIFE BUILDING, 200 PARK AVENUE, NEW YORK, NY, 10166, US

(21) Appl. No.: 10/699,167

(22) Filed: Oct. 31, 2003

(51) Int. Cl. E05B 15/16; E05B 67/24

(52) U.S. Cl. 70/38 A; 70/39; 70/53; 70/417

(57) ABSTRACT

The invention relates to a lock for two-wheel vehicles for the locking of a two-wheel vehicle. A section of the lock for two-wheel vehicles has ceramic reinforcement elements in a metal/ceramic composite. The ceramic reinforcement elements can be embedded in a matrix which is formed by a honeycomb structure or by a binding agent. Alternatively to this, a section of the lock for two-wheel vehicles is fully ceramic.

The invention relates to a lock for two-wheel vehicles for the securing of a two-wheel vehicle, in particular of a bicycle or of a motorcycle. Such locks for two-wheel vehicles usually have a lock body with a housing and a latching mechanism accommodated therein, and an additional latching part such as a rigid hoop (in the case of a hoop lock), a cable (in the case of a cable lock), a block (in the case of a brake disk lock) or the like.

Such locks for two-wheel vehicles should naturally be as secure against being broken open as possible. For this purpose, it is known, for example, to manufacture critical sections of the lock from hardened steel in order to impede a sawing through or breaking open of the respective lock section. Nevertheless, the desired degree of security against breaking open is not always achieved by the known measures.

It is therefore an object of the invention to provide a lock for two-wheel vehicles with increased security against being broken open.

This object is satisfied by a lock for two-wheel vehicles having the features of claim 1 and in particular in that a lock section has one or more ceramic reinforcement elements in a metal/ceramic composite or is made fully of ceramic material.

In accordance with a first aspect, a combination of a metal structure and of at least one ceramic reinforcement element is therefore provided. A single elongate or areal ceramic reinforcement element can, for example, be provided as an integrated hoop reinforcement or as a housing reinforcement. Or a plurality of ceramic reinforcement elements are provided, for example in the form of bars, spheres or loose or pressed granulate particles arranged adjacent to one another.

A metal/ceramic composite is formed in that the ceramic reinforcement element or elements is/are embedded or inserted into a metal structure or in that—vice versa—metal elements are integrated into a ceramic structure. Such a metal/ceramic composite combines the advantage of a viscid material (metal) with the advantage of a particularly hard material (ceramics). The ceramic portion within the relevant lock section therefore effects a clear impediment to a sawing open or cutting open of the relevant lock section due to its high hardness. At the same time, the—comparatively viscid—metal component of the composite prevents a smashing of the relevant lock section if a comparatively brittle ceramic material is used for the reinforcement elements.

In accordance with a second alternative aspect, the relevant lock section is fully ceramic, i.e. is made as a single ceramic element. This can prove to be particularly useful for such sections of the lock for two-wheel vehicles for which a relatively high hardness—in comparison with metal—is important. The hoop of a hoop lock, for example, or a housing section of a brake disk lock can be made fully of ceramic material in order to impede a sawing open or cutting open particularly effectively.

In both aspects, an advantageous optimization of the weight to be carried along is achieved by the use of a ceramic material with increased security against being broken open.

The said metal/ceramic composite is preferably formed in that the ceramic reinforcement elements are provided with a metal jacket or are poured or inserted into a metal jacket. The ceramic reinforcement elements can be inserted into the metal jacket alone, i.e. without additional structures. Alternatively to this, the ceramic reinforcement elements are integrated into a matrix (metal or non-metal) which is surrounded by the said metal jacket. The ceramic reinforcement elements can in particular be fixed in the metal jacket by a binding agent. The metal jacket can also simultaneously form the said matrix into which the ceramic reinforcement elements are integrated.

The lock for two-wheel vehicles can, for example, be a hoop lock, with the respective lock section being formed by a hoop of the hoop lock which has a hollow hoop made of metal in which the ceramic reinforcement elements are arranged. This hollow hoop therefore forms a jacket for the ceramic reinforcement elements. The hollow hoop is preferably hollow-cylindrical, in particular having a U shape.

It is of advantage for the ceramic reinforcement elements to have a diameter or—in the case of polygonal reinforcement elements—a diameter across flats which amounts to approximately 1/3 of the internal diameter of the said hollow hoop. Particularly high packing densities of the reinforcement elements inside the hoop can thereby be achieved.

As already mentioned, the ceramic reinforcement elements can be embedded into a matrix which is formed, for example, from an epoxy resin, an elastomer, a polymer, another plastic, a cement or a metal. This matrix can be a rigid structure into which the ceramic reinforcement elements are inserted. The matrix can, for example, be formed by a fixed honeycomb structure. Aluminum or an aluminum alloy can, for example, be considered for such a rigid structure made of metal. A matrix of aluminum or of an aluminum alloy with ceramic reinforcement elements made of aluminum oxide is particularly suitable.

Alternatively to this, the said matrix can be formed by a binding agent into which the ceramic reinforcement elements are poured or embedded or otherwise inserted while the binding agent is still liquid.

In both cases, the embedding of the ceramic reinforcement elements into the matrix brings about an advantageous damping of blows which are possibly carried out on the lock for two-wheel vehicles during a break-open attempt. The reinforcement elements are therefore protected against smashing by the matrix.

The matrix furthermore contributes to holding the individual reinforcement elements in their positions such that they cannot be released from the composite on cutting or sawing attacks.

A further advantage of the embedding of the ceramic reinforcement elements into a matrix consists of the fact that the reinforcement elements can be rotatably supported inside the matrix. If, in an attempt to saw apart the respective lock section, a saw acts on such a reinforcement element, the latter can follow the sawing movement by rotation about its longitudinal axis such that the effect of the action is even further weakened.

The matrix is preferably provided in addition to the said metal jacket. In the case of a metal matrix, however, this is not absolutely necessary, i.e. the ceramic reinforcement elements can also be embedded into a metal matrix without an additional metal jacket.

In particular in the case that the respective lock section is a hoop of a hoop lock, it is preferred for the ceramic reinforcement elements to have an elongate shape. Such elongate reinforcement elements can have any desired cross-section; a round cross-section or a polygonal cross-section, in particular a hexagonal or an octagonal cross-section is preferred. In these cases, a particularly high packing density of the ceramic reinforcement elements can be achieved inside a jacket.

Generally, the ceramic reinforcement elements can have the shape of cylinders, circle sectors, circle segments or prisms. In the case of hexagonal prisms, a packing density of approximately 79% is, for example, achieved when the diameter across flats of these prisms amounts to 0.32 times the internal diameter of a round hollow hoop which is filled with the reinforcement elements.

It is furthermore preferred for a plurality of elongate ceramic reinforcement elements to be arranged parallel to one another.

In accordance with a particularly preferred embodiment, a plurality of ceramic reinforcement elements arranged next to one another are arranged axially offset to one another and/or ceramic reinforcement elements arranged in series overlap in the axial direction. It is thereby, for example, avoided inside a metal jacket of the reinforcement elements that a gap extending over the whole cross-section occurs between the ceramic reinforcement elements at any position along the metal jacket. In other words, a saw with which, for example, a metal hoop filled with ceramic reinforcement elements should be sawn apart always encounters at least one reinforcement element, irrespective of the position along the metal hoop at which the saw is set on.

The ceramic reinforcement elements can have an aspect ratio of 1 to 1,000, with a diameter or a diameter across flats from 0.1 to 10 mm and with a length from 1 to 100 mm. In this connection, the aspect ratio is to be understood as the ratio of the large axis to the small axis of the reinforcement element, that is, for example in the case of a cylindrical reinforcement element, the ratio of the length to the diameter.

In particular a length between 10 and 20 mm and a diameter or—in the event of a polygonal cross-section—a diameter across flats between 0.7 and 1.5 mm can be provided for the ceramic reinforcement elements.

The said ceramic reinforcement elements can be made at least partly from Al₂O₃, ZrO₂, Si₃N₄, SiC, TiC, from a hard metal or from a cermet, with in particular cobalt-bonded tungsten carbide being possible as the hard metal.

The said lock section of the lock for two-wheel vehicles can also be a housing section, in particular a section of a housing of a brake disk lock. In this case, one or more ceramic reinforcement elements are therefore integrated into the housing or into a housing wall, or the housing has a fully ceramic housing section or a fully ceramic wall. It is preferred for this embodiment for the ceramic reinforcement elements to be areal. An integration of reinforcement elements into the housing is particularly simple when it is produced as a cast housing. Al₂O₃, ZrO₂, Si₃N₄, SiC, TiC or a cermet can be considered as ceramic materials, for example.

Further embodiments of the invention are recited in the dependent claims. The invention will be explained in the following by way of example with reference to the drawings.

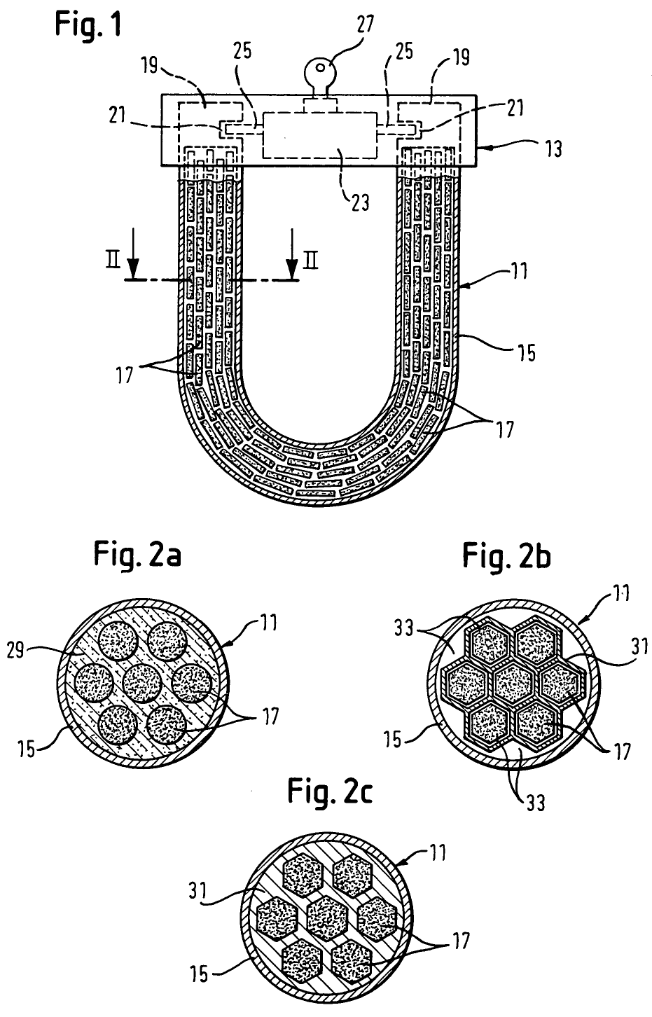

FIG. 1 shows a hoop lock with a hollow hoop in which ceramic reinforcement elements are arranged.

FIGS. 2a, 2b and 2c show cross-sections through different embodiments of the hoop in accordance with FIG. 1.

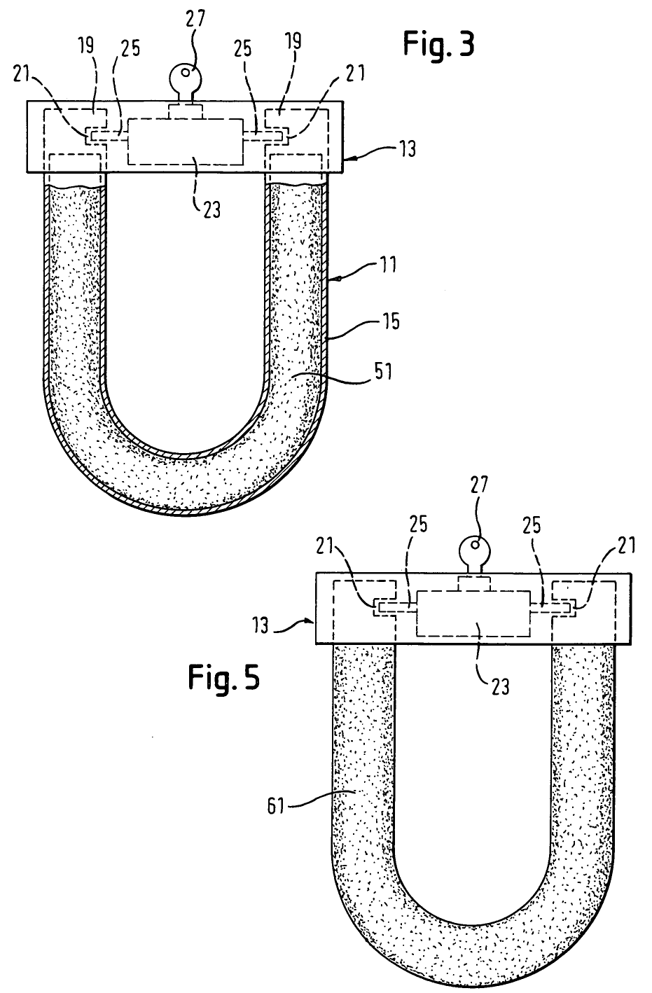

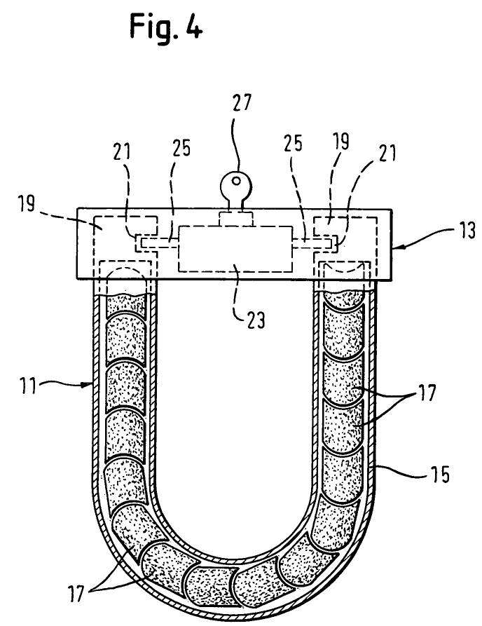

FIGS. 3 and 4 show different embodiments of a hoop lock with a hoop whose ceramic core is surrounded by a metal jacket.

FIG. 5 shows a hoop lock with a fully ceramic hoop.

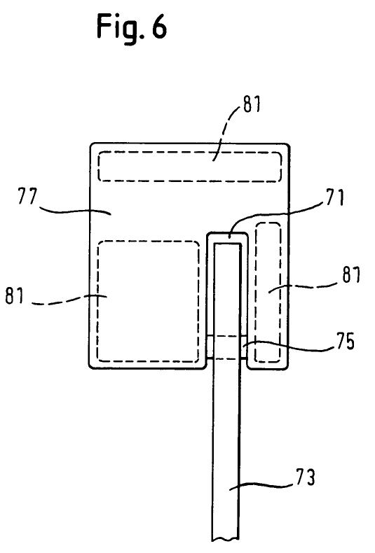

FIG. 6 shows a disk brake lock with a housing into which ceramic reinforcement elements are integrated.

FIG. 1 shows a hoop lock with a hoop 11 and a lock body 13. The hoop 11 has a hollow hoop 15 of hardened steel. A plurality of elongate ceramic reinforcement elements 17 are arranged inside the hollow hoop 15 and are embedded in a matrix, as will be explained in the following.

The hoop 11 has a U shape, with a latching section 19 of metal being molded at each of the two free ends. Each latching section 19 has a bolt receiver 21. The latching sections 19 of the two ends of the hoop 11 project into the lock body 13. The two latching sections 19 can there be latched in a manner known per se by means of a latching mechanism 23, with optionally two bolt elements 25 engaging into the bolt receivers 21. The latching mechanism 23 can be actuated by means of a key 27.

The ceramic reinforcement elements 17 consist, for example, of Al₂O₃, ZrO₂, Si₃N₄, SiC, TiC, a hard metal or of a cermet. The ceramic reinforcement elements 17 are aligned parallel to one another with respect to their elongate shape, with this alignment following the U shape of the hoop 11. Furthermore, adjacent reinforcement elements 17 are arranged axially offset to one another.

The lock for two-wheel vehicles shown in FIG. 1 serves for the securing of a two-wheel vehicle. For this purpose, a section of the two-wheel vehicle frame and a post or a street lamp are, for example, gripped around by the hoop 11. The hoop 11 is then closed in that the lock body 13 is latched at the hoop ends, as shown in FIG. 1.

In order to ensure a particularly high security against being broken open and in particular to prevent or at least impede the attempt of a sawing open or cutting open of the hoop 11, the hollow hoop 15 is filled with the ceramic reinforcement elements 17. The ceramic reinforcement elements 17 are characterized by a particularly high hardness which provides a particularly high resistance to a sawing tool or to a cutting tool such that a cutting apart of the hoop 11 can at best be achieved with a very high time effort.

At the same time, the hoop 11 cannot be smashed easily despite the use of a ceramic material. The fact contributes to this, on the one hand, that a plurality of ceramic reinforcement elements 17 are provided inside the hollow hoop 15 such that a plurality of individual ceramic units are present which cannot easily jointly be subjected to force or pressure. Above all, however, the ceramic reinforcement elements 17 form a metal/ceramic composite at least together with the hollow hoop 15, with the jacket formed by the hollow hoop 15 protecting the ceramic reinforcement elements 17 against a direct action on a breaking-open attempt.

The hollow hoop 15 can, for example, have an external diameter between 13 and 20 mm with a wall thickness from 2 to 5 mm. The diameter or the diameter across flats of the ceramic reinforcement elements 17 can, for example, amount to approximately 1/3 of the internal diameter of the hollow hoop 15, with lower values, for example between 0.7 and 1.5 mm, also being possible.

The ceramic reinforcement elements 17 can, for example, have a length between 10 and 20 mm, with either all reinforcement elements 17 having the same length or with different lengths being provided to facilitate the explained advantageous axial offset of the reinforcement elements 17 relative to one another.

FIG. 2a shows a cross-section of the hoop 11 in accordance with FIG. 1 in accordance with a first embodiment. In this embodiment, seven ceramic reinforcement elements 17 are arranged next to one another in each case, with six reinforcement elements 17 surrounding one central reinforcement element 17 in a substantially uniform division (hexagonal arrangement).

The reinforcement elements 17 are embedded in a matrix which is formed by a binding agent 29. The binding agent 29 is, for example, an epoxy resin, an elastomer, a polymer, another plastic, a cement or a metal. The binding agent 29 fixes the ceramic reinforcement elements 17 inside the hollow hoop 15 in the axial and radial directions. Moreover, the binding agent 19 brings about an additional protection of the reinforcement elements 17 against blows or other external actions. The arrangement of ceramic reinforcement elements 17, which are embedded in the binding agent 29 of, for example, epoxy resin, on the one hand, and the hollow hoop 15 of hardened steel, on the other hand, jointly form a metal/ceramic composite.

The manufacture of the U-shaped hoop 11 with the ceramic reinforcement elements (17) contained therein can take place, for example, in that the matrix material or the binding agent 29 is poured into the pre-shaped hollow hoop 15 from both ends in a liquid state with reinforcement elements 17 contained therein, with the binding agent 29 subsequently hardening in the hollow hoop 15. This procedure is facilitated if the hoop 11 rather has a V shape instead of the U shape shown in FIG. 1.

Alternatively to this, the hollow hoop 15 can initially be made in a straight line, that is in the form of a metal tube. This metal tube is filled from one end with the liquid binding agent 29 and the reinforcement elements 17 contained therein. A subsequent bending of the hollow hoop 15 into the U shape shown in FIG. 1 can take place subsequently, while the binding agent 29 is still liquid or after the binding agent 29 has already hardened. In particular in the latter case, it is of advantage for the ceramic reinforcement elements 17 to have a comparatively small length in order not to be damaged during the bending of the hollow hoop 15.

Alternatively to the elongate ceramic reinforcement elements 17 shown in FIGS. 1 and 2a, a ceramic granulate can, for example, also be provided which is added to the binding agent 29.

FIG. 2b shows a cross-section through the hoop 11 in accordance with FIG. 1 in accordance with a second embodiment. In this embodiment, seven reinforcement elements 17 are likewise provided next to one another, with these reinforcement elements 17, however, each having a hexagonal cross-section. The reinforcement elements 17 are inserted into a matrix which is formed by a honeycomb structure 31 of aluminum or of an aluminum alloy. The honeycomb structure 31 and the reinforcement elements 17, which are preferably made of aluminum oxide, thus form a metal/ceramic composite which is subsequently jacketed by the hollow hoop 15.

FIG. 2c shows a cross-section through the hoop 11 in accordance with FIG. 1 in accordance with a third embodiment. A solid honeycomb structure 31 is provided here which serves as a matrix into which seven ceramic reinforcement elements 17 with a hexagonal cross-section are inserted in a shape matched manner in a hexagonal arrangement. The honeycomb structure 31 is inserted into a hollow hoop 15 of metal in a shape matched manner.

A particularly high packing density is achieved inside the hollow hoop 15 by the shapes and arrangements of the ceramic reinforcement elements 17 shown in FIGS. 2b and 2c.

The manufacture of a hoop 11 in accordance with the embodiments shown in FIGS. 2b and 2c can take place in a simple manner, for example, in that the ceramic reinforcement elements 17 are first inserted into the honeycomb structure 31 and the honeycomb structure 31 filled in this manner is subsequently inserted into a metal tube. The metal tube is then bent to form the U-shaped hollow hoop 15 shown in FIG. 1. The honeycomb structure 31 is admittedly rigid, but sufficiently flexible to permit the explained bending. In a subsequent enhancement procedure (tempering and quenching) of the hollow hoop 15, the honeycomb structure 31 can also be temporarily melted such that, after a further hardening of the honeycomb structure 31, the ceramic reinforcement elements 17 are fixed in place. Possibly present hollow spaces 33 (FIG. 2b) can be filled with powdered matrix material prior to the enhancement process for the optimization of the process.

It must still be mentioned with respect to the hoop lock shown in FIGS. 1, 2a, 2b and 2c that a different number of reinforcement elements 17 arranged next to one another can also be provided, for example a number from three to twelve reinforcement elements 17.

It must furthermore be remarked that the ceramic reinforcement elements 17 can—alternatively to the embedding in a matrix 29, 31—also be inserted loosely into the hollow hoop 15.

Finally, in addition to the hoop 11, the lock body 13 can also have ceramic reinforcement elements in order to additionally impede an attack on the lock body 13. For example, ceramic reinforcement elements can be integrated into the housing of the lock body 13, as will be explained in the following in connection with FIG. 6.

FIGS. 3, 4 and 5 show further embodiments of a hoop lock in which the same parts as in FIG. 1 are characterized with the same reference numerals.

FIG. 3 shows a hoop lock whose hoop 11 has a single U-shaped ceramic reinforcement element 51 which is jacketed by a hollow hoop 15 of hardened steel. The solid ceramic core of the hoop 11 impedes a sawing apart or a cutting apart of the hoop 11, while the jacket protects the reinforcement element 51 against direct actions from outside, in particular by blows, by means of the hollow hoop 15.

FIG. 4 shows a modification of the hoop lock in accordance with FIG. 3 in which a plurality of ceramic reinforcement elements 17 are inserted in series in substantially shape matched manner into the hollow hoop 15 of hardened steel. The ceramic insert of this hoop 11 is therefore axially segmented. The reinforcement elements 17 have a cylindrical base form with—in the manner of a so-called insulating bead—one respective end face being concavely arched and the other end face being convexly arched. Each convex end face of a reinforcement element 17 engages into the concave end face of the adjacent reinforcement element 17. In this manner, the reinforcement elements 17 can also be arranged in an axially overlapping manner along the U-shaped bend of the hollow hoop 15. Planar gaps between the reinforcement elements 17, which could facilitate a sawing apart or cutting apart of the hoop 11, are thereby avoided.

The reinforcement elements 17 can optionally also be made hollow with a wire or a steel core for the threading on of the individual reinforcement elements 17.

FIG. 5 shows a hoop lock whose hoop 61 is fully ceramic. Optionally, the two ends of the hoop 61 can have latching sections of metal to ensure a particularly reliable cooperation with the latching mechanism 23 of the lock body 13 (not shown in FIG. 5). The hoop 61 can be made partly or in full from Al₂O₃, ZrO₂, Si₃N₄, SiC, TiC, hard metal or a cermet.

FIG. 6 shows a brake disk lock which engages around a brake disk 73 of a motorcycle with a receiving slot 71 in a manner known per se. A bolt 75 travels through the receiving slot 71 and through a bore provided in the brake disk 73 such that the brake disk 73 is hereby secured against unauthorized movement.

A plurality of ceramic reinforcement elements 81 are integrated into the housing 77 of metal in order additionally to secure the brake disk lock shown against attempts to break it open. For example, one elongate and one areal ceramic reinforcement element 81 are provided in the environment of the receiving slot 71. An elongate ceramic reinforcement element 81 is likewise integrated into the housing wall at the end face of the housing 77 lying opposite the receiving slot 71. The ceramic reinforcement elements 81 can be made for example from Al₂O₃, ZrO₂, Si₃N₄, SiC, TiC or a cermet.

### Reference numeral list

11 hoop
13 lock body
15 hollow hoop
17 ceramic reinforcement element
19 latching section
21 bolt receiver
23 latching mechanism
25 bolt element
27 key
29 binding agent
31 honeycomb structure
33 hollow space
51 ceramic reinforcement element
61 hoop
71 receiver slot
73 brake disk
75 bolt
77 housing
81 ceramic reinforcement element

1. A lock for two-wheeled vehicles for the securing of a two=wheel vehicle, in which a lock section (11, 61, 77) has one or more ceramic reinforcement elements (17, 51, 81) in a metal/ceramic composite or is fully ceramic (61).

2. A lock for two-wheeled vehicles in accordance with claim 1, characterized in that the ceramic reinforcement element (17, 51, 81) are provided with a metal jacket (15, 31, 77).

3. A lock for two-wheeled vehicles in accordance with claim 1, characterized
in that the lock for two-wheeled vehicles is a hoop lock; and
in that the lock section is a hoop (11) lock which has a hollow hoop (15) in which the ceramic reinforcement elements (17, 51) are arranged.

4. A lock for two-wheeled vehicles in accordance with claim 3, characterized in that the diameter of the ceramic reinforcement elements (17) amount to approximately 1/3 of the internal diameter of the hollow hoop (15).

5. A lock for two-wheeled vehicles in accordance with claim 1, characterized in that the lock section is a section of a housing (77) of the lock for two-wheel vehicles, in particular of a brake disk lock.

6. A lock for two-wheeled vehicles in accordance with claim 1, characterized in that the ceramic reinforcement elements (17) are embedded in a matrix (29, 31) of an epoxy resin, of a plastic, of an elastomer, of a polymer, of a cement, or of a metal.

7. A lock for two-wheeled vehicles in accordance with claim 6, characterized in that the matrix is a solid honeycomb structure (31) into which the ceramic reinforcement elements (17) are inserted.

8. A lock for two-wheeled vehicles in accordance with claim 6, characterized in that the matrix is a honeycomb structure (31) of metal into which the ceramic reinforcement element (17) are melted such that the ceramic reinforcement elements (17) are fixed in position.

9. A lock for two-wheeled vehicles in accordance with claim 6, characterized in that the matrix is formed by a binding agent (29) into which the ceramic reinforcement elements (17) are poured.

10. A lock for two-wheeled vehicles in accordance with claim 1, characterized in that the ceramic reinforcement elements (17) have an elongate shape.

11. A lock for two-wheeled vehicles in accordance with claim 1, characterized in that they ceramic reinforcement elements (17) have a round or a polygonal cross-section.

12. A lock for two-wheeled vehicles in accordance with claim 1, characterized in that a plurality of ceramic reinforcement elements (17) are arranged parallel to one another.

13. A lock for two-wheeled vehicles in accordance with claim 1, characterized in that a plurality of ceramic reinforcement elements (17) are arranged axially offset to one another.

14. A lock for two-wheeled vehicles in accordance with claim 1, characterized in that the ceramic reinforcement elements (17) are arranged axially overlapping, with the ceramic reinforcement elements (17) preferably having convex and concave end faces, with the convex end face of a reinforcement element (17) and the concave end face of a reinforcement element (17) adjacent thereto engaging into one another.

15. A lock for two-wheeled vehicles in accordance with claim 1, characterized in that between three and twelve reinforcement elements (17) are arranged next to one another.

16. A lock for two-wheeled vehicles in accordance with claim 1, characterized in that the ceramic reinforcement elements (17) have an aspect ratio from 1 to 1,000, with a diameter from 0.1 to 10 mm and with a length from 1 to 100 mm.

17. A lock for two-wheeled vehicles in accordance with claim 1, characterized in that the ceramic reinforcement elements (17) have a length from 10 to 20 mm.

18. A lock for two-wheeled vehicles in accordance with claim 1, characterized in that the ceramic reinforcement elements (17) have a length from 0.7 to 1.5 mm.

19. A lock for two-wheeled vehicles in accordance with claim 1, characterized in that the ceramic reinforcement elements (17) are made partly or completely from Al₂O₃, ZrO₂, Si₃N₄, SiC, TiC, a hard metal or a cermet.

20. A lock for two-wheeled vehicles in accordance with claim 1, characterized
in that the lock for two-wheel vehicles is a hoop lock; and
in that the hoop section is a fully ceramic hoop (61) of the hoop lock.

21. A lock for a two-wheel vehicles in accordance with claim 20, characterized in that the filly ceramic hoop (61) is made partly or completely from Al₂O₃, ZrO₂, Si₃N₄, SiC, TiC, a hard metal or a cermet.
